(19) United States
(12) Patent Application Publication
(10) Pub. No.: US 2023/0332961 A1
(43) Pub. Date: Oct. 19, 2023

(54) LOAD SENSOR

(71) Applicant: Panasonic Intellectual Property Management Co., Ltd., Osaka (JP)

(72) Inventors: Susumu URAGAMI, Osaka (JP); Hiroyuki FURUYA, Osaka (JP); Yuta MORIURA, Osaka (JP); Takashi MATSUMOTO, Osaka (JP); Hironobu UKITSU, Osaka (JP); Yodai MATSUMURA, Osaka (JP)

(21) Appl. No.: 18/213,749

(22) Filed: Jun. 23, 2023

Related U.S. Application Data
(63) Continuation of application No. PCT/JP21/40827, filed on Nov. 5, 2021.

(30) Foreign Application Priority Data
Dec. 24, 2020 (JP) 2020-214672

(51) Int. Cl. G01L 1/14

(52) U.S. Cl. CPC G01L 1/14

(57) ABSTRACT

A load sensor includes: two base members disposed so as to face each other; two electrically-conductive elastic bodies respectively disposed on opposing faces of the two base members; and a plurality of conductor wires disposed between the two electrically-conductive elastic bodies. The plurality of conductor wires are disposed under a condition that, when a diameter of each conductor wire is not greater than 0.3 mm, a gap between the plurality of conductor wires is not less than 0.6 mm, and when the diameter of each conductor wire is greater than 0.3 mm, the gap between the plurality of conductor wires is not less than twice the diameter of each conductor wire.

### CROSS REFERENCE TO RELATED APPLICATION

This application is a continuation of International Application No. PCT/JP2021/040827 filed on Nov. 5, 2021, entitled “LOAD SENSOR”, which claims priority under 35 U.S.C. Section 119 of Japanese Patent Application No. 2020-214672 filed on Dec. 24, 2020, entitled “LOAD SENSOR”. The disclosures of the above applications are incorporated herein by reference.

### BACKGROUND OF THE INVENTION

### Field of the Invention

The present invention relates to a load sensor that detects a load applied from outside, based on change in capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. 2018/096901 describes a pressure-sensitive element including: two first electrically-conductive members each formed from a sheet-shaped electrically-conductive rubber; a second electrically-conductive member sandwiched by the two first electrically-conductive members; and a dielectric body formed so as to cover the second electrically-conductive member.

In the above configuration, usually, when the number of second electrically-conductive members sandwiched by the two first electrically-conductive members is increased, the dynamic range of the pressure-sensitive element is assumed to be widened. However, studies by the inventors have revealed that the dynamic range cannot be appropriately widened by merely increasing the number of disposed second electrically-conductive members (conductor wires).

### SUMMARY OF THE INVENTION

A major aspect of the present invention relates to a load sensor configured to detect a load applied to a sensor part from outside, based on change in capacitance. The load sensor according to the present aspect includes: two base members disposed so as to face each other; two electrically-conductive elastic bodies respectively disposed on opposing faces of the two base members; and a plurality of conductor wires disposed between the two electrically-conductive elastic bodies. The plurality of conductor wires are disposed under a condition that, when a diameter of each conductor wire is not greater than 0.3 mm, a gap between the plurality of conductor wires is not less than 0.6 mm, and when the diameter of each conductor wire is greater than 0.3 mm, the gap between the plurality of conductor wires is not less than twice the diameter of each conductor wire.

According to the load sensor of the present aspect, as long as the above condition is satisfied, the change width of the capacitance according to the load can be widened in accordance with increase in the number of conductor wires disposed in a sensor part. Therefore, by increasing the number of conductor wires disposed in a sensor part according to the above condition, it is possible to appropriately widen the dynamic range of the sensor part.

The effects and the significance of the present invention will be further clarified by the description of the embodiment below. However, the embodiment below is merely an example for implementing the present invention. The present invention is not limited to the embodiment below in any way.

### BRIEF DESCRIPTION OF THE DRAWINGS

FIG. 1A is a perspective view schematically showing a base member on the lower side and electrically-conductive elastic bodies set on an opposing face of the base member on the lower side, according to an embodiment;

FIG. 1B is a perspective view schematically showing a state where a plurality of conductor wires are set on the base member, according to the embodiment;

FIG. 2A is a perspective view schematically showing a base member on the upper side and electrically-conductive elastic bodies set on an opposing face of the base member on the upper side, according to the embodiment;

FIG. 2B is a perspective view schematically showing a load sensor of which assembly has been completed, according to the embodiment;

FIG. 3A and FIG. 3B are each a cross-sectional view schematically showing surroundings of a conductor wire viewed in an X-axis negative direction, according to the embodiment;

FIG. 4 is a plan view schematically showing the inside of the load sensor viewed in a Z-axis negative direction, according to the embodiment;

FIG. 5A is a cross-sectional view schematically showing disposition of the conductor wires, according to a first simulation;

FIG. 5B is a graph showing a relationship between the load and the capacitance obtained when the number of conductor wires arranged in a Y-axis direction was changed, according to the first simulation;

FIG. 6A is a cross-sectional view schematically showing disposition of the conductor wires, according to a second simulation;

FIG. 6B is a graph showing a relationship between the load and the capacitance under Conditions 1, 2, according to the second simulation;

FIG. 7A is a cross-sectional view schematically showing disposition of the conductor wires, according to a third simulation;

FIG. 7B is a table showing a relationship between hardness and young's modulus, according to the third simulation;

FIG. 8 is a deformation image showing a state of deflection of the electrically-conductive elastic bodies and the base members, according to the third simulation;

FIGS. 9A, 9B are each a diagram schematically showing a deformation image of the electrically-conductive elastic bodies and the base members, according to the third simulation;

FIGS. 10A, 10B are each a graph showing a relationship between the diameter of the conductor wire and the minimum necessary gap for allowing the electrically-conductive elastic bodies and the base members to be appropriately deflected, according to the third simulation; and

FIG. 11 is a schematic diagram showing a state where the maximum number of conductor wires are disposed in a sensor part, according to the embodiment.

It is noted that the drawings are solely for description and do not limit the scope of the present invention in any way.

### DETAILED DESCRIPTION

The load sensor according to the present invention is applicable to a load sensor of a management system or an electronic apparatus that performs processing in accordance with an applied load.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

Examples of the electronic apparatus include a vehicle-mounted apparatus (car navigation system, audio apparatus, etc.), a household electrical appliance (electric pot, IH cooking heater, etc.), a smartphone, an electronic paper, an electronic book reader, a PC keyboard, a game controller, a smartwatch, a wireless earphone, a touch panel, an electronic pen, a penlight, lighting clothes, and a musical instrument. In an electronic apparatus, a load sensor is provided to an input part that receives an input from a user.

The load sensor in the embodiment below is a capacitance-type load sensor that is typically provided in a load sensor of a management system or an electronic apparatus as described above. Such a load sensor may be referred to as a “capacitance-type pressure-sensitive sensor element”, a “capacitive pressure detection sensor element”, a “pressure-sensitive switch element”, or the like. The load sensor in the embodiment below is used to detect the load applied to a sensor part from outside, based on change in capacitance. The load sensor in the embodiment below is connected to a detection circuit, and the load sensor and the detection circuit form a load detection device. The embodiment below is an example of embodiments of the present invention, and the present invention is not limited to the embodiment below in any way.

Hereinafter, the embodiment of the present invention will be described with reference to the drawings. For convenience, X-, Y-, and Z-axes orthogonal to each other are indicated in the drawings. The Z-axis direction is the height direction of a load sensor 1.

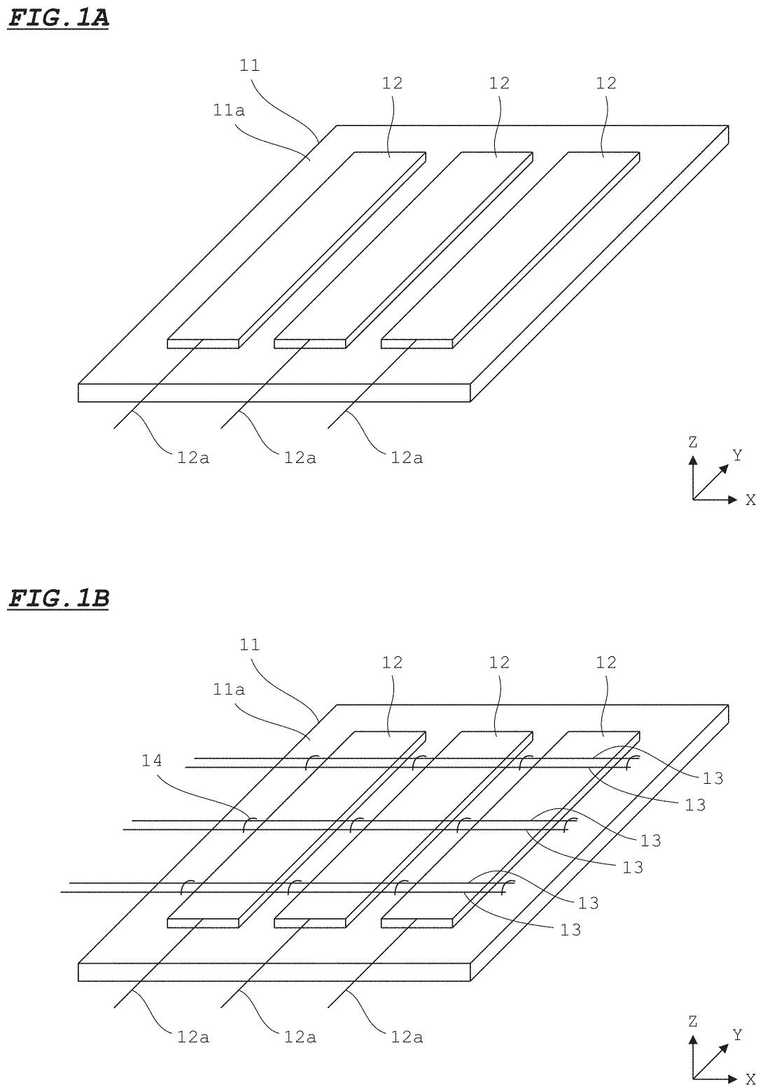

FIG. 1A is a perspective view schematically showing a base member 11, and three electrically-conductive elastic bodies 12 set on an opposing face 11a (the face on the Z-axis positive side) of the base member 11.

The base member 11 is an insulative member having elasticity, and has a flat plate shape parallel to an X-Y plane. The base member 11 is formed from a non-electrically-conductive resin material or a non-electrically-conductive rubber material. The resin material used in the base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 12 are formed on the opposing face 11a (the face on the Z-axis positive side) of the base member 11. In FIG. 1A, three electrically-conductive elastic bodies 12 are formed on the opposing face 11a of the base member 11. Each electrically-conductive elastic body 12 is an electrically-conductive member having elasticity. The electrically-conductive elastic bodies 12 each have a band-like shape that is long in the Y-axis direction, and are formed so as to be arranged with a predetermined interval therebetween in the X-axis direction. At an end portion on the Y-axis negative side of each electrically-conductive elastic body 12, a cable 12a electrically connected to the electrically-conductive elastic body 12 is set.

Each electrically-conductive elastic body 12 is formed on the opposing face 11a of the base member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the opposing face 11a of the base member 11. However, the method for forming the electrically-conductive elastic body 12 is not limited to the printing methods.

Each electrically-conductive elastic body 12 is formed from a resin material and an electrically-conductive filler dispersed therein, or from a rubber material and an electrically-conductive filler dispersed therein.

Similar to the resin material used in the base member 11 described above, the resin material used in the electrically-conductive elastic body 12 is a resin material of at least one type selected from the group consisting of a styrene-based resin, a silicone-based resin (polydimethylpolysiloxane (e.g., PDMS)), an acrylic resin, a rotaxane-based resin, a urethane-based resin, and the like, for example. Similar to the rubber material used in the base member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electrically-conductive elastic body 12 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT:PSS (i.e., a complex composed of poly(3,4-ethylenedioxythiophene) (PEDOT) and polystyrene sulfonate (PSS)); electrically-conductive fibers such as a metal-coated organic matter fiber and a metal wire (fiber state); and the like, for example.

FIG. 1B is a perspective view schematically showing a state where a plurality of conductor wires 13 are set on the base member 11.

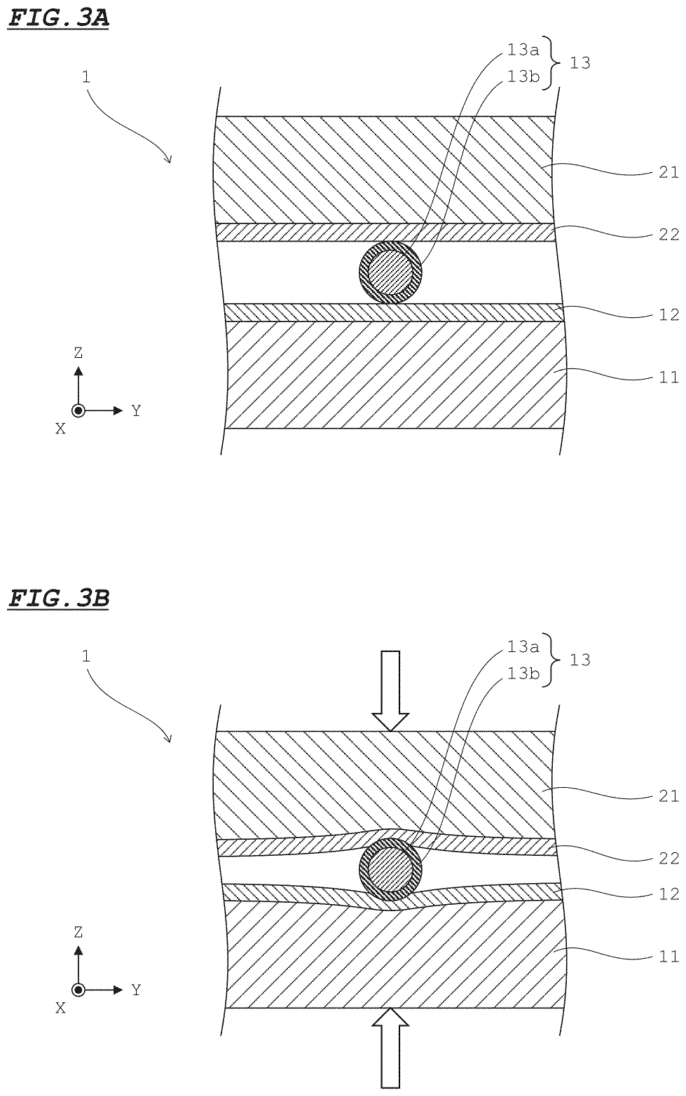

The plurality of conductor wires 13 are disposed so as to be superposed on the upper faces of the three electrically-conductive elastic bodies 12. The plurality of conductor wires 13 are disposed, extending in the X-axis direction, so as to extend across the three electrically-conductive elastic bodies 12. Here, two conductor wires 13 are disposed so as to be adjacent to each other, and three sets of two adjacent conductor wires 13 are disposed. The sets of the conductor wires 13 are each disposed so as to cross the electrically-conductive elastic bodies 12, and are disposed so as to be arranged with a predetermined interval therebetween, along the longitudinal direction (the Y-axis direction) of the electrically-conductive elastic bodies 12. Each conductor wire 13 includes an electrically-conductive member having a linear shape, and a dielectric body formed on the surface of the electrically-conductive member. The configuration of the conductor wire 13 will be described later with reference to FIGS. 3A, 3B.

After the three sets of two adjacent conductor wires 13 have been disposed as shown in FIG. 1B, each set of the conductor wires 13 is set to the base member 11 by threads 14 so as to be movable in the direction (the X-axis direction) in which the conductor wires 13 extend. In the example shown in FIG. 1B, twelve threads 14 set each set of the conductor wires 13 to the base member 11 at positions other than the positions where the electrically-conductive elastic bodies 12 and the conductor wires 13 overlap each other. Each thread 14 is implemented by a chemical fiber, a natural fiber, a mixed fiber of the chemical fiber and the natural fiber, or the like. The two adjacent conductor wires 13 included in one set are connected to each other in a subsequent wiring or circuit. The two adjacent conductor wires 13 may be connected at end portions on the X-axis positive side. The number of conductor wires 13 included in one set is not limited to 2, and may be 3 or greater.

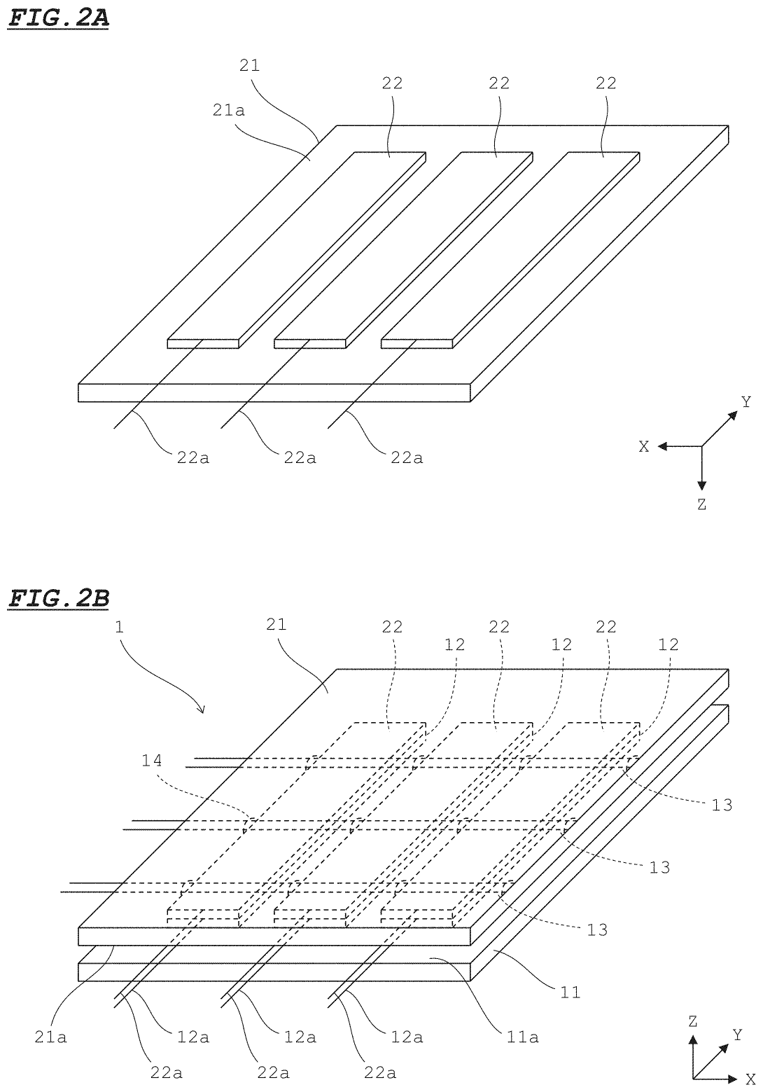

FIG. 2A is a perspective view schematically showing a base member 21 disposed so as to be superposed on the upper side of the base member 11, and three electrically-conductive elastic bodies 22 set on an opposing face 21a (the face on the Z-axis negative side) of the base member 21.

The base member 21 has the same size and shape as those of the base member 11, and is formed from the same material as that of the base member 11. The electrically-conductive elastic bodies 22 are formed, on the opposing face 21a of the base member 21, at positions opposing the electrically-conductive elastic bodies 12, and are formed so as to be arranged with a predetermined interval therebetween in the X-axis direction. Each electrically-conductive elastic body 22 has the same size and shape as those of the electrically-conductive elastic body 12, and is formed from the same material as that of the electrically-conductive elastic body 12. Similar to the electrically-conductive elastic body 12, the electrically-conductive elastic body 22 is formed on the face on the Z-axis negative side of the base member 21 by a predetermined printing method. The method for forming the electrically-conductive elastic body 22 is not limited to the printing methods, either. At an end portion on the Y-axis negative side of each electrically-conductive elastic body 22, a cable 22a electrically connected to the electrically-conductive elastic body 22 is set.

FIG. 2B is a perspective view schematically showing a state where the structure in FIG. 2A is set on the structure in FIG. 1B.

The structure shown in FIG. 2A is disposed from above (the Z-axis positive side) the structure shown in FIG. 1B. At this time, the base member 11 and the base member 21 are disposed such that: the opposing face 11a and the opposing face 21a face each other; and the electrically-conductive elastic bodies 12 and the electrically-conductive elastic bodies 22 are superposed with each other. Then, outer peripheral four sides of the base member 21 are connected to the outer peripheral four sides of the base member 11 with a silicone rubber-based adhesive, a thread, or the like, whereby the base member 11 and the base member 21 are fixed to each other. Accordingly, the sets of two adjacent conductor wires 13 are sandwiched by the electrically-conductive elastic bodies 12 and the electrically-conductive elastic bodies 22 disposed in the up-down direction. Thus, as shown in FIG. 2B, the load sensor 1 is completed.

FIGS. 3A, 3B are each a cross-sectional view schematically showing surroundings of a conductor wire 13 viewed in the X-axis negative direction. FIG. 3A shows a state where no load is applied, and FIG. 3B shows a state where loads are applied.

As shown in FIGS. 3A, 3B, the conductor wire 13 is composed of an electrically-conductive member 13a and a dielectric body 13b formed on the electrically-conductive member 13a. The electrically-conductive member 13a is a wire member having a linear shape, and the dielectric body 13b covers the surface of the electrically-conductive member 13a.

The electrically-conductive member 13a is formed from an electrically-conductive metal material, for example. Other than this, the electrically-conductive member 13a may be composed of a core wire made of glass, and an electrically-conductive layer formed on the surface of the core wire.

Alternatively, the electrically-conductive member 13a may be composed of a core wire made of resin, and an electrically-conductive layer formed on the surface of the core wire, for example. As the electrically-conductive member 13a, for example, a valve action metal such as aluminum (Al), titanium (Ti), tantalum (Ta), niobium (Nb), zirconium (Zr), or hafnium (Hf); tungsten (W); molybdenum (Mo); copper (Cu); nickel (Ni); silver (Ag); gold (Au); or the like is used. The dielectric body 13b has an electric insulation property, and is formed from a resin material, a ceramic material, a metal oxide material, or the like, for example.

As shown in FIG. 3A, when no load is applied, the force applied between the electrically-conductive elastic body 12 and the conductor wire 13, and the force applied between the electrically-conductive elastic body 22 and the conductor wire 13 are substantially zero. From this state, as shown in FIG. 3B, when a load is applied in the upward direction to the lower face of the base member 11 and a load is applied in the downward direction to the upper face of the base member 21, the electrically-conductive elastic bodies 12, 22 and the base members 11, 21 are deformed by the conductor wire 13.

As shown in FIG. 3B, when loads are applied, the conductor wire 13 is brought close to the electrically-conductive elastic bodies 12, 22 so as to be wrapped by the electrically-conductive elastic bodies 12, 22, and the contact area between the conductor wire 13 and the electrically-conductive elastic body 12, 22 increases. Accordingly, the capacitance between the electrically-conductive member 13a and the electrically-conductive elastic body 12 and the capacitance between the electrically-conductive member 13a and the electrically-conductive elastic body 22 change. Then, the capacitance in the region of the conductor wire 13 is detected, whereby the load applied to this region is calculated.

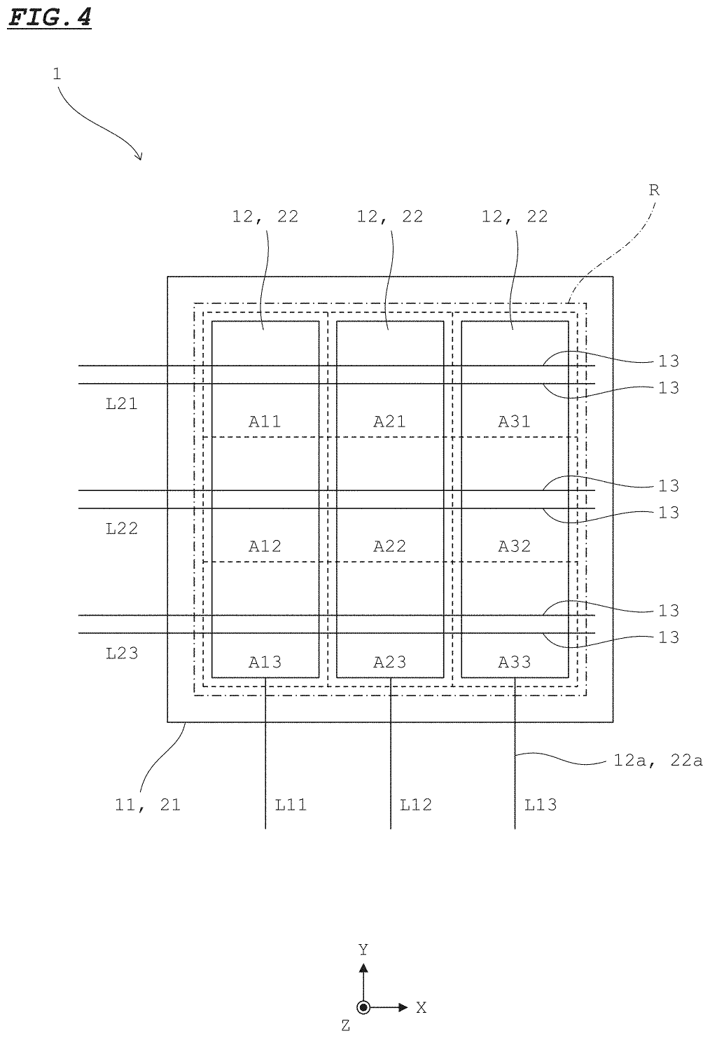

FIG. 4 is a plan view schematically showing the inside of the load sensor 1 viewed in the Z-axis negative direction. In FIG. 4, threads 14 are not shown, for convenience.

In a measurement region R of the load sensor 1, nine sensor parts arranged in the X-axis direction and the Y-axis direction are set. Specifically, nine regions obtained by dividing the measurement region R into three in the X-axis direction and dividing the measurement region R into three in the Y-axis direction are assigned as the nine sensor parts. The boundary of each sensor part is in contact with the boundary of a sensor part adjacent thereto. The nine sensor parts correspond to nine positions where the electrically-conductive elastic bodies 12, 22 and the sets of two adjacent conductor wires 13 cross each other. At these nine positions, nine sensor parts A11, A12, A13, A21, A22, A23, A31, A32, A33 in each of which capacitance changes in accordance with a load are formed.

Each sensor part includes the electrically-conductive elastic bodies 12, 22 and a set of two adjacent conductor wires 13, and the two conductor wires 13 serving as a set forms one pole (e.g., positive pole) for capacitance, and the electrically-conductive elastic bodies 12, 22 form the other pole (e.g., negative pole) for capacitance. That is, the electrically-conductive member 13a (see FIGS. 3A, 3B) in the two conductor wires 13 serving as a set forms one electrode of the load sensor 1 (capacitance-type load sensor), the electrically-conductive elastic bodies 12, 22 form the other electrode of the load sensor 1 (capacitance-type load sensor), and the dielectric body 13b (see FIGS. 3A, 3B) in the two conductor wires 13 serving as a set corresponds to a dielectric body that defines capacitance in the load sensor 1 (capacitance-type load sensor).

When a load is applied in the Z-axis direction to each sensor part, the two conductor wires 13 serving as a set are pressed against and sink into the electrically-conductive elastic body 12, 22 due to the load. Accordingly, the contact area between the two conductor wires 13 serving as a set and the electrically-conductive elastic body 12, 22 changes, and the capacitance between the two conductor wires 13 and the electrically-conductive elastic body 12, 22 changes.

An end portion on the X-axis negative side of each conductor wire 13, an end portion on the Y-axis negative side of each cable 12a, and an end portion on the Y-axis negative side of each cable 22a are connected to a detection circuit provided for the load sensor 1.

In FIG. 4, the cables 12a, 22a drawn from the three sets of electrically-conductive elastic bodies 12, 22 are indicated as lines L11, L12, L13, and the electrically-conductive members 13a in the three sets of conductor wires 13 are indicated as lines L21, L22, L23. The positions at which the electrically-conductive elastic bodies 12, 22 connected to the line L11 cross the lines L21, L22, L23 are the sensor parts A11, A12, A13, respectively. The positions at which the electrically-conductive elastic bodies 12, 22 connected to the line L12 cross the lines L21, L22, L23 are the sensor parts A21, A22, A23, respectively. The positions at which the electrically-conductive elastic bodies 12, 22 connected to the line L13 cross the lines L21, L22, L23 are the sensor parts A31, A32, A33, respectively.

When a load is applied to the sensor part A11, the contact area between the two conductor wires 13 serving as a set and the electrically-conductive elastic body 12, 22 increases in the sensor part A11. Therefore, when the capacitance between the line L11 and the line L21 is detected, the load applied to the sensor part A11 can be calculated. Similarly, in another sensor part as well, when the capacitance between two lines crossing each other in the other sensor part is detected, the load applied to the other sensor part can be calculated.

Meanwhile, in the above configuration, since two conductor wires 13 are disposed for one sensor part, the contact area between the conductor wires 13 and the electrically-conductive elastic body 12, 22 in one sensor part increases compared with that in a case where one conductor wire 13 is disposed. Therefore, when the number of conductor wires 13 disposed in one sensor part is increased, the change amount of the capacitance in the sensor part during load application can be accordingly increased, whereby the dynamic range (the range where the load can be detected) of the sensor part can be widened.

The inventors verified, through a first simulation, how the dynamic range of the sensor part is widened by further increasing the number of conductor wires 13 disposed in the sensor part.

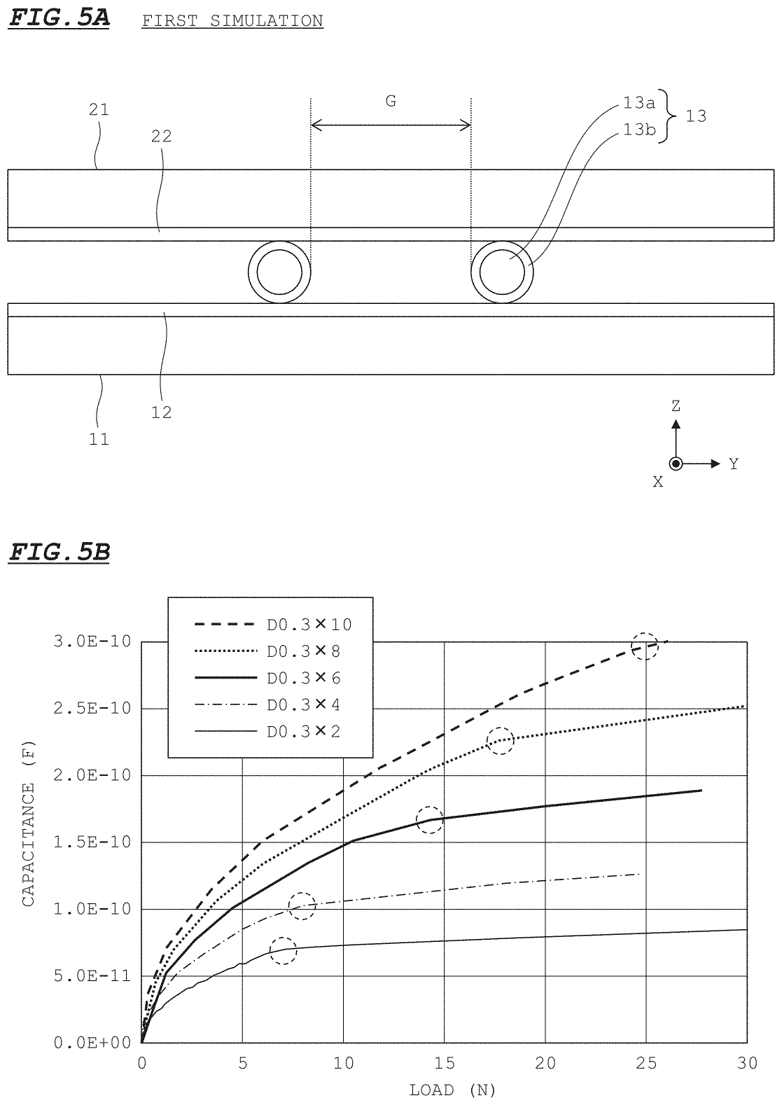

FIG. 5A is a cross-sectional view schematically showing disposition of the conductor wires 13, according to the first simulation.

In the first simulation, similar to the configuration shown in FIGS. 3A, 3B, each conductor wire 13 was composed of the electrically-conductive member 13a and the dielectric body 13b covering the surface of the electrically-conductive member 13a. The base member 11 and the electrically-conductive elastic body 12 were disposed on the lower side of the conductor wires 13 and the base member 21 and the electrically-conductive elastic body 22 were disposed on the upper side of the conductor wires 13. The diameter of each conductor wire 13 was set to 0.3 mm. A plurality of the conductor wires 13 were disposed with a predetermined gap G therebetween in the Y-axis direction. The gap G between adjacent conductor wires 13 was set so as to allow the electrically-conductive elastic bodies 12, 22 and the base members 11, 21 between the adjacent conductor wires 13 to be sufficiently deflected.

Under this condition, the number of conductor wires 13 was set to 2, 4, 6, 8, or 10, and the relationship between the load and the capacitance when each number was set was verified.

FIG. 5B is a graph showing a relationship between the load and the capacitance obtained when the number of conductor wires 13 arranged in the Y-axis direction was changed, according to the first simulation. In the graph in FIG. 5B, the horizontal axis represents the load (N) and the vertical axis represents the capacitance (F).

In each graph, a broken-line circle indicates an inflection point of the curve. In a load sensor, normally, the load in a range from 0 to the inflection point is the load range (dynamic range) where the sensor part can detect the load. Therefore, it was confirmed that, under the condition of the first simulation, the dynamic range is increased in accordance with increase in the number of conductor wires 13, as shown in FIG. 5B.

Next, the inventors verified, through a second simulation, how a pitch P between conductor wires 13, which changes due to increase in the number of conductor wires 13 disposed in one sensor part, influences the dynamic range. That is, in a case where a plurality of conductor wires are disposed in the width range of the sensor part, when the number of disposed conductor wires is increased, the pitch between adjacent conductor wires is accordingly decreased, and the gap between adjacent conductor wires is accordingly decreased. Thus, the inventors verified, through the second simulation, how the pitch and the gap between adjacent conductor wires influence the dynamic range of the sensor part when the number of conductor wires 13 disposed in one sensor part is increased.

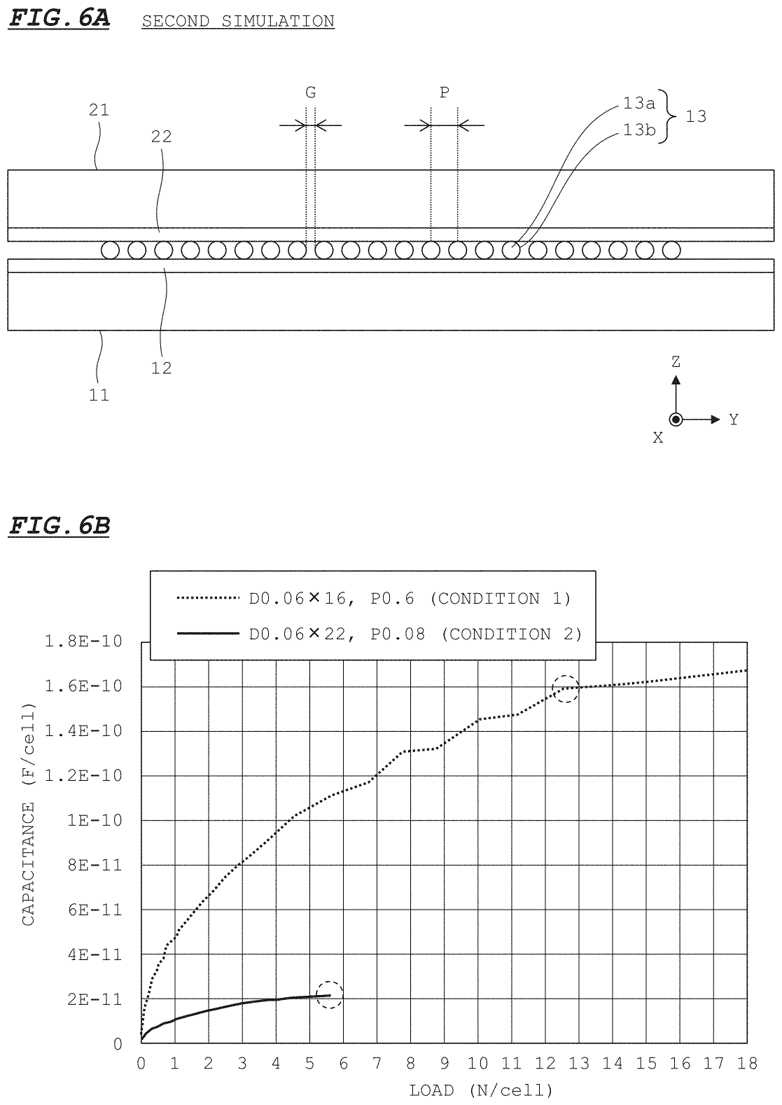

FIG. 6A is a cross-sectional view schematically showing disposition of the conductor wires 13, according to the second simulation.

In the second simulation as well, similar to the case in FIG. 5A, a plurality of the conductor wires 13, the base members 11, 21, and the electrically-conductive elastic bodies 12, 22 were disposed. In the second simulation, Condition 1 was set such that the diameter of each conductor wire 13 was 0.06 mm, the number of conductor wires 13 was 16, and the pitch P (the distance between centers) was 0.6 mm. Condition 2 was set such that the diameter of each conductor wire 13 was 0.06 mm, the number of conductor wires 13 was 22, and the pitch P was 0.08 mm. In Conditions 1, 2, the range including all of the conductor wires 13 was defined as the range of the sensor part.

Using these two conditions, the relationship between the load and the capacitance under each condition was verified.

FIG. 6B is a graph showing a relationship between the load and the capacitance under Conditions 1, 2, according to the second simulation. In the graph in FIG. 6B, the horizontal axis represents the load (N) applied to the sensor part, and the vertical axis represents the capacitance (F).

As shown in FIG. 6B, under Condition 1, a dynamic range equivalent to that obtained when six conductor wires 13 each having a diameter of 0.3 mm were arranged in the first simulation shown in FIGS. 5A, 5B was obtained. Thus, it was confirmed that, when 16 conductor wires 13 each having a diameter of 0.06 mm are disposed in the sensor part, the dynamic range of the sensor part can be widened. However, under Condition 2, even though the number of conductor wires 13 included in the sensor part was greater than that of Condition 1, the dynamic range was significantly decreased compared with that under Condition 1.

From this, it was possible to confirm that, by merely increasing the number of conductor wires 13 included in one sensor part, the dynamic range of the sensor part cannot be appropriately widened. That is, it was possible to confirm that, even if the number of disposed conductor wires 13 is increased, if the pitch P or the gap G between adjacent conductor wires 13 is decreased, the dynamic range of the sensor part is rather decreased.

The inventors considered the reason as follows. Since the pitch P and the gap G under Condition 2 are much smaller than those under Condition 1, even if the load applied to the sensor part is increased, the electrically-conductive elastic bodies 12, 22 and the base members 11, 21 are less likely to be deflected between adjacent two conductor wires 13, whereby increase in the capacitance and the dynamic range is suppressed.

Therefore, the inventors examined, through a third simulation, what condition of two conductor wires 13 allows the electrically-conductive elastic bodies 12, 22 and the base members 11, 21 to be appropriately deflected and allows the dynamic range to be widened.

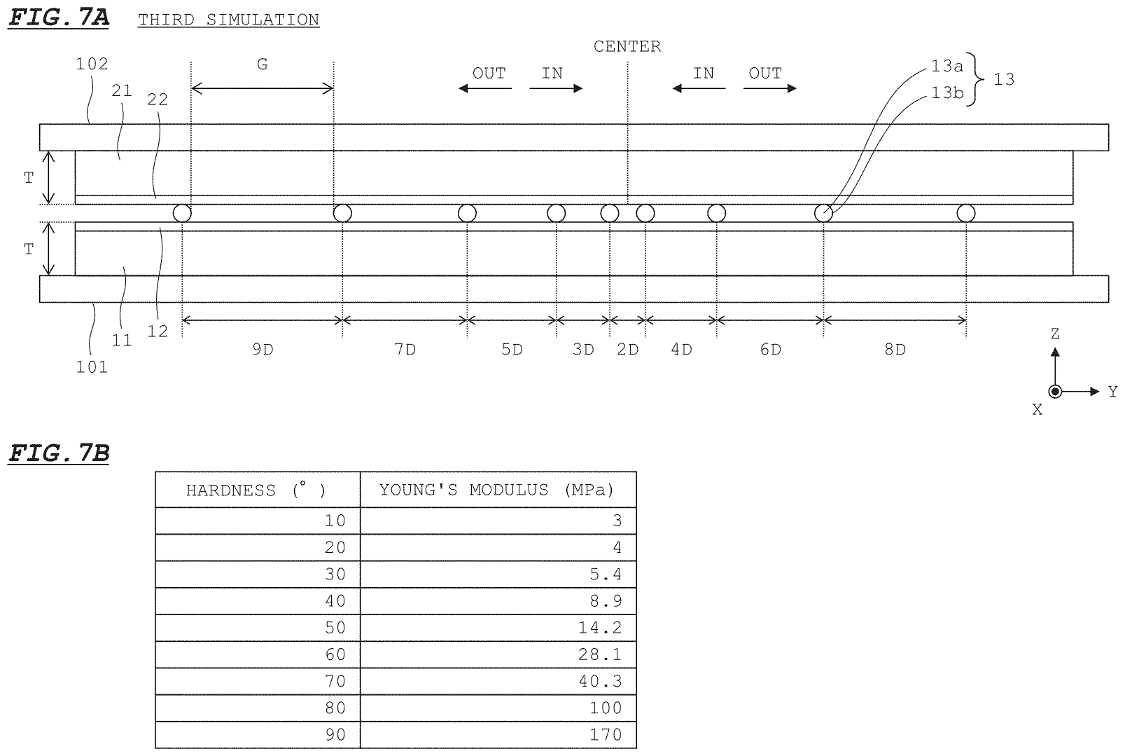

FIG. 7A is a cross-sectional view schematically showing disposition of the conductor wires 13, according to the third simulation.

In third simulation, the base member 11 was disposed on the lower side of the electrically-conductive elastic body 12, and a metal plate 101 was disposed on the lower side of the base member 11. The base member 21 was disposed on the upper side of the electrically-conductive elastic body 22, and a metal plate 102 was disposed on the upper side of the base member 21. The metal plate 101, 102 was implemented by a material that is not deflected even if a load is applied thereto in the up-down direction.

The conductor wires 13 were disposed such that the pitch P was increased by a diameter D of each conductor wire 13 alternately and stepwise from the center toward the outside (the Y-axis positive direction and the Y-axis negative direction). That is, the pitch P of two conductor wires 13 closest to the center was set to 2D, the pitch P of two conductor wires 13 positioned on the Y-axis negative side with respect to the center was set to 3D, and further, the pitch P of two conductor wires 13 positioned on the Y-axis positive side with respect to the center was set to 4D. In this manner, nine conductor wires 13 were arranged in the Y-axis direction such that the pitch P was increased by D alternately in the Y-axis direction from 2D to 9D.

Verification was performed with respect to each of cases where the hardness of the electrically-conductive elastic bodies 12, 22 and the base members 11, 21 was 10° and 90°. As shown in FIG. 7B, a hardness of 10° corresponds to a Young's modulus of 3 MPa and a hardness of 90° corresponds to a Young's modulus of 170 MPa. Normally, the hardness of the electrically-conductive elastic bodies 12, 22 and the base members 11, 21 suitable for the load sensor 1 is 40° to 60°. Therefore, in the third simulation, in order to enable sufficient verification on this range, the hardness was set to 10° and 90° and verification was performed for each hardness.

Further, the diameter D of the conductor wire 13 was set to 0.075 mm, 0.15 mm, 0.25 mm, 0.3 mm, 0.4 mm, 0.5 mm, 0.6 mm, and 0.8 mm, and the third simulation was performed with respect to each case. The sum of the thicknesses of the electrically-conductive elastic body 12 and the base member 11, and the sum of the thicknesses of the electrically-conductive elastic body 22 and the base member 21 were each defined as T, and when the diameter D was not greater than 0.3 mm, T was set to 1 mm, and when the diameter D was greater than 0.3 mm, T was set to 2 mm.

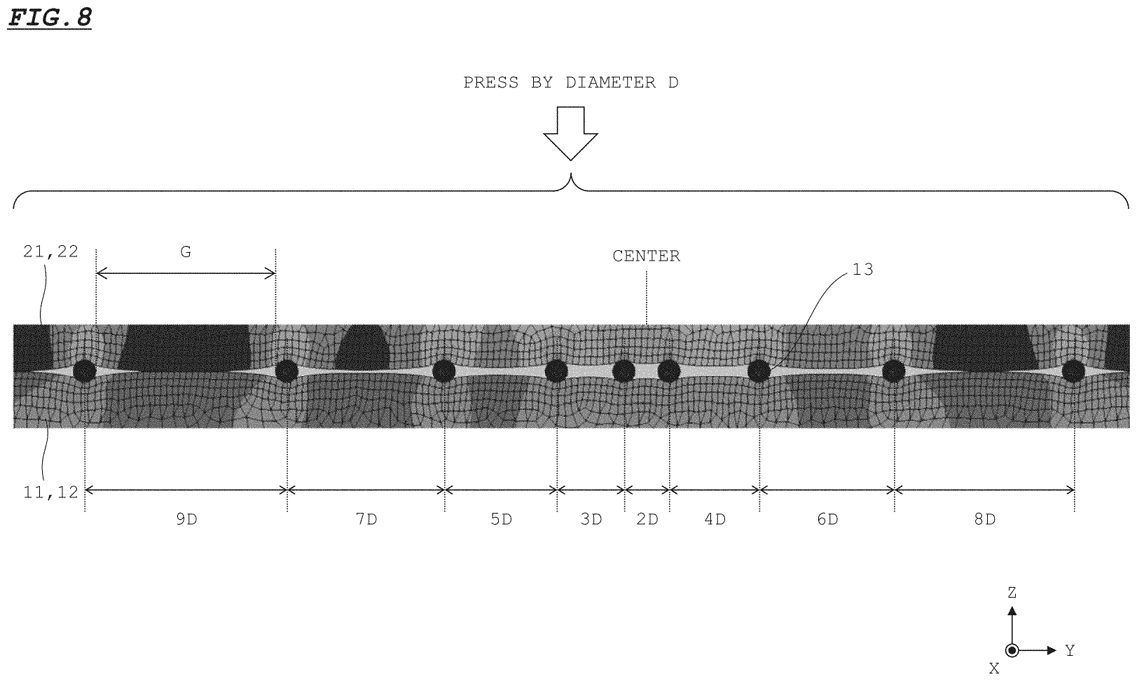

FIG. 8 is an image (hereinafter, referred to as a “deformation image”) showing a state of deflection of the electrically-conductive elastic bodies 12, 22 and the base members 11, 21, according to the third simulation.

In the third simulation, assuming that a load is applied, the metal plate 102 (see FIG. 7A) on the upper side was pressed by the diameter D in the downward direction, whereby the electrically-conductive elastic bodies 12, 22 and the base members 11, 21 were deformed. In the third simulation, with reference to the deformation image, it was determined whether the electrically-conductive elastic bodies 12, 22 and the base members 11, 21 were appropriately deformed as described below.

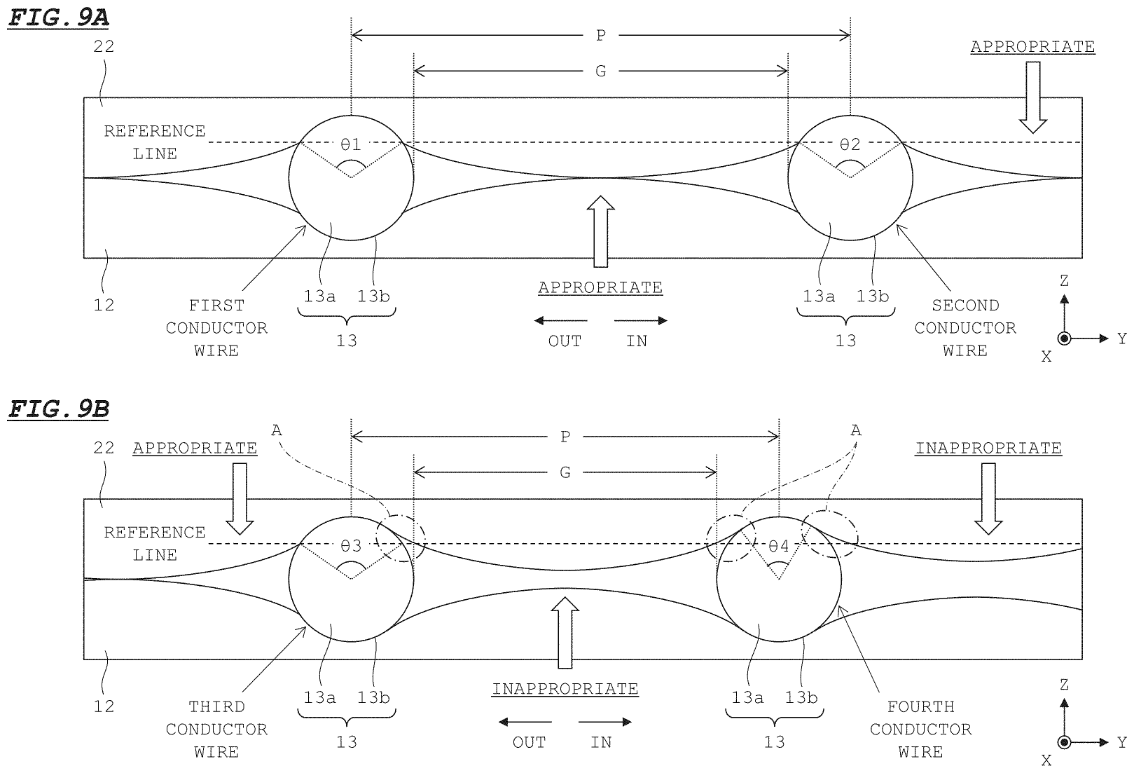

FIGS. 9A, 9B are each a diagram schematically showing a deformation image of the electrically-conductive elastic bodies 12, 22 and the base members 11, 21, according to the third simulation.

In the third simulation, whether or not the pitch P (the gap G) is appropriate is determined, based on whether or not the upper and lower electrically-conductive elastic bodies 12, 22 come into contact with each other in the range of the pitch P (the gap G) when the metal plate 102 (see FIG. 7A) on the upper side is pressed by the diameter D in the downward direction. When the upper and lower electrically-conductive elastic body 12, 22 come into contact with each other, it is determined that the electrically-conductive elastic bodies 12, 22 and the base members 11, 21 are appropriately deflected in the range of the pitch P (the gap G), and it is determined that the pitch P (the gap G) is appropriate. On the other hand, when the upper and lower electrically-conductive elastic bodies 12, 22 do not come into contact with each other, it is determined that the electrically-conductive elastic bodies 12, 22 and the base members 11, 21 are not appropriately deflected in the range of the pitch P (the gap G), and it is determined that the pitch P (the gap G) is not appropriate.

An example of the determination method will be described below. Here, out of two conductor wires 13 forming a pitch P (the gap G) subjected to the determination, the conductor wire 13 on the outer side with respect to the center shown in FIG. 8 is focused on, and it is determined whether or not the electrically-conductive elastic bodies 12, 22 and the base members 11, 21 are appropriately deflected in the pitch P (the gap G) subjected to the determination.

In FIG. 9A, two conductor wires 13 arranged so as to be adjacent to each other from the left side (the Y-axis negative side) toward the right side (the Y-axis positive side) are referred to as a “first conductor wire” and a “second conductor wire”, respectively. In FIG. 9B, two conductor wires 13 arranged so as to be adjacent to each other from the left side (the Y-axis negative side) toward the right side (the Y-axis positive side) are referred to as a “third conductor wire” and a “fourth conductor wire”, respectively. Here, for convenience, the first to fourth conductor wires are assumed to be positioned on the left side (the Y-axis negative side) with respect to the center shown in FIG. 8. Therefore, the first and second conductor wires are positioned on the outer side with respect to the third and fourth conductor wires.

The central angle of the first conductor wire corresponding to the contact range between the first conductor wire and the electrically-conductive elastic body 12, 22 is defined as a contact angle θ1, the central angle of the second conductor wire corresponding to the contact range between the second conductor wire and the electrically-conductive elastic body 12, 22 is defined as a contact angle θ2, the central angle of the third conductor wire corresponding to the contact range between the third conductor wire and the electrically-conductive elastic body 12, 22 is defined as a contact angle θ3, and the central angle of the fourth conductor wire corresponding to the contact range between the fourth conductor wire and the electrically-conductive elastic body 12, 22 is defined as a contact angle θ4.

Here, as shown in FIG. 9A, when the electrically-conductive elastic bodies 12, 22 come into contact with each other at an outer position and an inner position with respect to the first conductor wire, and the end points on the outer side and the inner side corresponding to the contact angle θ1 of the first conductor wire are at the same height, the straight line (a straight broken line) connecting the end points on the outer side and the inner side corresponding to the contact angle θ1 of the first conductor wire is set as a reference line.

In this case, the electrically-conductive elastic bodies 12, 22 are in contact with each other in the range of the pitch P (the gap G) on the inner side of the first conductor wire. Therefore, when both end points of the contact angle θ1 of the first conductor wire are at the position of the reference line in the up-down direction, it is determined that the electrically-conductive elastic bodies 12, 22 and the base members 11, 21 are appropriately deflected in the range of the pitch P (the gap G) on the inner side of the first conductor wire, and that the pitch P (the gap G) is appropriate.

Subsequently, as shown in FIG. 9A, when both of the end points on the outer side and the inner side corresponding to the contact angle θ2 of the second conductor wire are at the position of the reference line in the up-down direction, it is determined that the electrically-conductive elastic bodies 12, 22 and the base members 11, 21 on the upper and lower sides are appropriately deflected in the range of the pitch P (the gap G) on the inner side of the second conductor wire.

Subsequently, as shown in FIG. 9B, when the end point on the inner side corresponding to the contact angle θ3 of the third conductor wire is on the outer side (here, on the upper side) of the reference line with respect to the center of the conductor wire 13, it is determined that the electrically-conductive elastic bodies 12, 22 and the base member 11, 21 on the upper and lower sides are not appropriately deflected in the range of the pitch P (the gap G) on the inner side of the third conductor wire. That is, in the case of FIG. 9B, in the vicinity of the end point on the inner side corresponding to the contact angle θ3, a region A where there is no contact with the electrically-conductive elastic bodies 12, 22 is formed on the outer side of the reference line with respect to the center of the conductor wire 13. In this case, in the range of the pitch P (the gap G) on the inner side of the third conductor wire, the upper and lower electrically-conductive elastic bodies 12, 22 are not in contact with each other. Therefore, in this case, it is determined that the electrically-conductive elastic bodies 12, 22 and the base members 11, 21 on the upper and lower sides are not appropriately deflected in the range of the pitch P (the gap G) on the inner side of the third conductor wire, and that the pitch P (the gap G) is not appropriate.

As shown in FIG. 9B, when the electrically-conductive elastic bodies 12, 22 and the base members 11, 21 on the upper and lower sides are not appropriately deflected in the range of the pitch P (the gap G) on the inner side of the third conductor wire, the regions A where there is no contact with the electrically-conductive elastic bodies 12, 22 are formed also in the vicinities of the end points on the outer side and the inner side corresponding to the contact angle θ4 of the fourth conductor wire. Therefore, it is determined that the electrically-conductive elastic bodies 12, 22 and the base members 11, 21 on the upper and lower sides are not appropriately deflected in the range of the pitch P (the gap G) on the inner side of the fourth conductor wire, either.

Similarly, also with respect to the conductor wires 13 positioned on the right side with respect to the center, whether or not the pitch P (the gap G) is appropriate is determined with the left-right sides of the FIGS. 9A, 9B reversed. In this case, based on whether or not the end point on the inner side (the Y-axis negative side) of the contact angle of the conductor wire 13 is at the position of the reference line, it is determined whether or not the pitch P (the gap G) on the inner side (the Y-axis negative side) of the conductor wire 13 is appropriate. That is, when the end point on the inner side (the Y-axis negative side) of the contact angle of the conductor wire 13 is at the position of the reference line, it is determined that the electrically-conductive elastic bodies 12, 22 and the base members 11, 21 on the upper and lower sides are appropriately deflected in the range of the pitch P (the gap G) on the inner side (the Y-axis negative side) of the conductor wire 13, and that the pitch P (the gap G) is appropriate. On the other hand, when the end point on the inner side (the Y-axis negative side) of the contact angle of the conductor wire 13 is on the upper side of the reference line, it is determined that the electrically-conductive elastic bodies 12, 22 and the base members 11, 21 on the upper and lower sides are not appropriately deflected in the range of the pitch P (the gap G) on the inner side (the Y-axis negative side) of the conductor wire 13, and that the pitch P (the gap G) is not appropriate.

With reference back to FIG. 8, the determination as described with reference to FIGS. 9A, 9B is sequentially performed from the outer side on the left side and the right side with respect to the center. Thus, in the example in FIG. 8, for example, it is determined that: on the left side with respect to the center, the electrically-conductive elastic bodies 12, 22 and the base members 11, 21 are appropriately deflected at the position where the pitch P is 9D, and the electrically-conductive elastic bodies 12, 22 and the base members 11, 21 are not appropriately deflected at the position where the pitch P is 7D; and on the right side with respect to the center, the electrically-conductive elastic bodies 12, 22 and the base members 11, 21 are appropriately deflected at the position where the pitch P is 8D, and the electrically-conductive elastic bodies 12, 22 and the base members 11, 21 are not appropriately deflected at the position where the pitch P is 6D. In this case, the minimum necessary pitch P for allowing the electrically-conductive elastic bodies 12, 22 and the base members 11, 21 to be appropriately deflected is determined to be 8D.

The determination like this was performed for each of two kinds of the hardness of the electrically-conductive elastic bodies 12, 22 and the base members 11, 21 and eight kinds of the diameter D of the conductor wire 13, and for each case, the minimum necessary pitch P for allowing the electrically-conductive elastic bodies 12, 22 and the base members 11, 21 to be appropriately deflected was obtained.

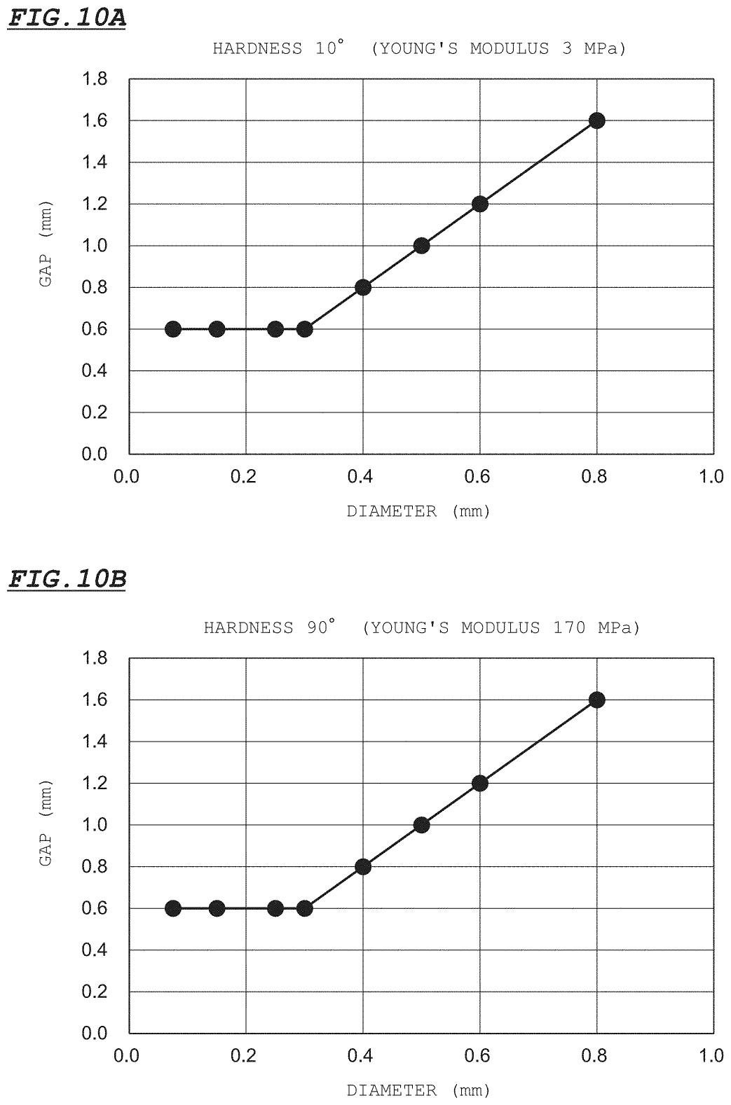

FIGS. 10A, 10B are each a graph showing a relationship between the diameter D of the conductor wire 13 and the minimum necessary gap G for allowing the electrically-conductive elastic bodies 12, 22 and the base members 11, 21 to be appropriately deflected, according to the third simulation.

FIG. 10A is a graph obtained when the hardness of the electrically-conductive elastic bodies 12, 22 and the base members 11, 21 was 10° (Young's modulus of 3 MPa). FIG. 10B is a graph obtained when the hardness of the electrically-conductive elastic bodies 12, 22 and the base members 11, 21 was 90° (Young's modulus of 170 MPa). In FIGS. 10A, 10B, every two detection points adjacent to each other are connected to each other by a straight line. The gap G corresponding to each diameter D is a value obtained by subtracting the diameter D from the pitch P obtained through the procedure described with reference to FIG. 8 to FIG. 9B.

In each graph in FIGS. 10A, 10B, the gap G was a constant value of 0.6 mm when the diameter D was not greater than 0.3 mm, and the gap G was a value twice as large as the diameter D when the diameter D was not less than 0.3 mm. As described above, the gap G (the pitch P) obtained through the procedure described with reference to FIG. 8 to FIG. 9B is the minimum necessary gap G (the pitch P) for allowing the electrically-conductive elastic bodies 12, 22 and the base members 11, 21 to be appropriately deflected. Therefore, it is understood that the value of the gap G necessary for allowing the electrically-conductive elastic bodies 12, 22 and the base members 11, 21 to be appropriately deflected only needs to be a value not less than that represented by the straight line shown in FIGS. 10A, 10B.

Thus, the following was found. That is, when a plurality of the conductor wires 13 are arranged with the gap G therebetween, if the electrically-conductive elastic bodies 12, 22 and the base members 11, 21 are to be appropriately deflected in the gap G, the diameter D of the conductor wire 13 and the gap G only need to satisfy Formulae (1), (2) below.

When D≤0.3 mm, G≥0.6 mm (1)

When D>0.3 mm, G≥2D (2)

Thus, for example, in a case where a plurality of the conductor wires 13 are disposed for one sensor part as shown in FIG. 4, if the diameter D of the conductor wire 13 and the gap G are set so as to satisfy the above Formulae (1), (2), the electrically-conductive elastic bodies 12, 22 and the base members 11, 21 in the sensor part are appropriately deflected. Therefore, the plurality of the conductor wires 13 shown in FIG. 4 are also disposed so as to satisfy the above Formulae (1), (2). Accordingly, the dynamic range of the sensor part can be widened.

In a case where the conductor wires 13 are disposed to be as many as possible in a sensor part to widen the dynamic range of the sensor part, if the maximum number of conductor wires 13 are disposed so as to satisfy the above Formulae (1), (2), the dynamic range of the sensor part can be widened to the maximum extent.

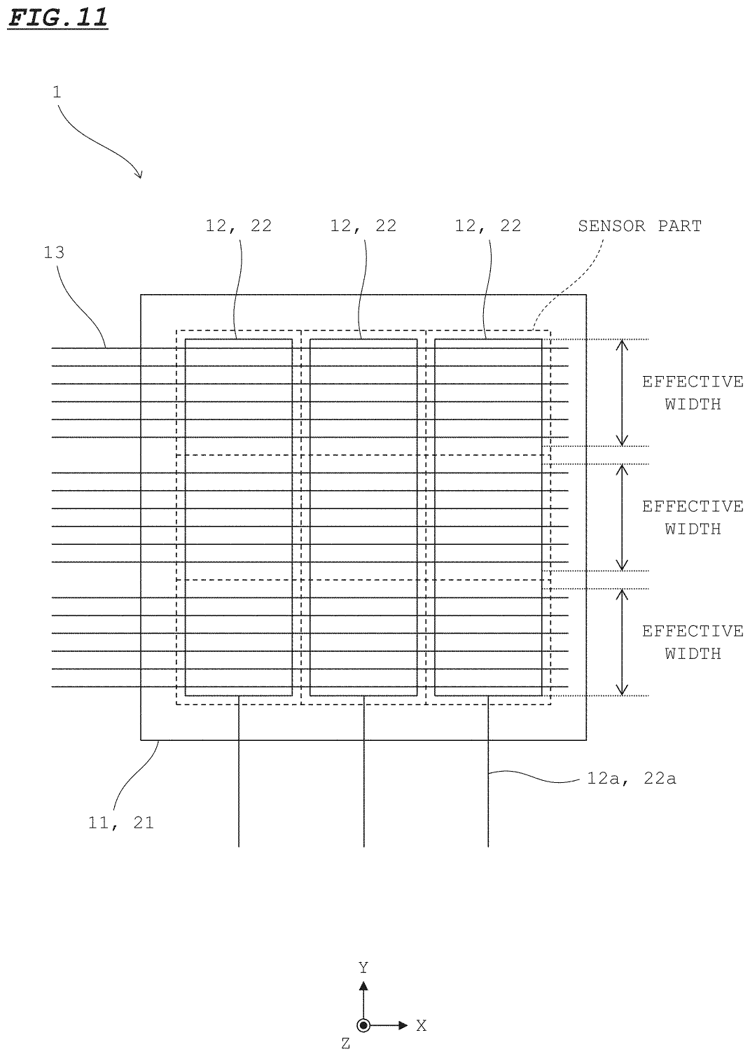

FIG. 11 is a schematic diagram showing a state where the maximum number of conductor wires 13 are disposed in a sensor part, under a condition that the electrically-conductive elastic bodies 12, 22 and the base members 11, 21 in the sensor part are appropriately deflected.

For example, when the diameter of the conductor wire 13 is assumed to be 0.6 mm and the effective width in the Y-axis direction of the sensor part is assumed to be 10 mm, six conductor wires 13 can be disposed in one sensor part, as shown in FIG. 11. That is, as shown in FIGS. 10A, 10B, when the diameter of the conductor wire 13 is 0.6 mm, if the gap G between the conductor wires 13 is 1.2 mm, the electrically-conductive elastic bodies 12, 22 and the base members 11, 21 are appropriately deflected. Therefore, in this case, if six conductor wires 13 are disposed at an equal interval with a gap G of 1.2 mm therebetween, the distance between the centers of the conductor wire 13 on the most Y-axis positive side and the conductor wire 13 on the most Y-axis negative side is 9.0 mm, and the maximum number of conductor wires 13 can be disposed in one sensor part having an effective width of 10 mm.

As described with reference to FIG. 7B, the hardness of the electrically-conductive elastic bodies 12, 22 and the base members 11, 21 suitable for the load sensor 1 is about 40° to 60° (Young's modulus of about 8.9 MPa to 28.1 Mpa), and the hardness set in the third simulation is 10° and 90°. That is, the hardness set in the third simulation is set to be outside 40° to 60° mentioned above. As shown in FIGS. 10A, 10B, irrespective of the hardness, the relationship between the diameter D and the gap G is similar. Therefore, when the load sensor 1 includes the electrically-conductive elastic bodies 12, 22 and the base members 11, 21 that have a normal hardness, it can be said that the above Formulae (1), (2) are effective.

### Effects of the Embodiment

According to the embodiment, the following effects are exhibited.

As shown in the above Formulae (1), (2), a plurality of the conductor wires 13 are disposed under a condition that, when the diameter D of each conductor wire 13 is not greater than 0.3 mm, the gap G between the plurality of the conductor wires 13 is not less than 0.6 mm, and when the diameter D of each conductor wire 13 is greater than 0.3 mm, the gap G between the plurality of the conductor wires 13 is not less than twice the diameter D of each conductor wire 13. According to this configuration, as long as the condition of the above Formulae (1), (2) is satisfied, the change width of the capacitance according to the load can be widened in accordance with increase in the number of conductor wires 13 disposed in a sensor part. Therefore, by increasing the number of conductor wires 13 disposed in a sensor part according to the above condition, it is possible to appropriately widen the dynamic range of the sensor part.

When the maximum number of conductor wires 13 satisfying the condition of the above Formulae (1), (2) are disposed, the change width of the capacitance according to the load can be widened to the maximum extent. Therefore, the dynamic range of the load detection in the sensor part can be widened to the maximum extent.

Two electrically-conductive elastic bodies 12, 22 are disposed, extending in one direction (the Y-axis direction), a plurality of sensor parts are disposed in the direction in which the two electrically-conductive elastic bodies 12, 22 extend, and a plurality of the conductor wires 13 satisfying the condition of the above Formulae (1), (2) are disposed in each of the sensor parts. In this case as well, with respect to the plurality of the sensor parts, the dynamic range of each sensor part can be widened.

A plurality of sets of the two electrically-conductive elastic bodies 12, 22 are disposed in one direction (the X-axis direction), a plurality of the conductor wires 13 satisfying the condition of the above Formulae (1), (2) are disposed along the plurality of sets, and a sensor part is disposed at each of positions where the plurality of sets of the two electrically-conductive elastic bodies 12, 22 and the plurality of the conductor wires 13 cross each other. In this case as well, with respect to the plurality of the sensor parts, the dynamic range of each sensor part can be widened.

As shown in FIGS. 3A, 3B, each conductor wire 13 includes an electrically-conductive member 13a having a linear shape, and a dielectric body 13b covering the electrically-conductive member 13a. According to this configuration, by merely covering the surface of the electrically-conductive member 13a by the dielectric body 13b, it is possible to set the dielectric body 13b between the electrically-conductive elastic bodies 12, 22 and the electrically-conductive member 13a.

<Other Modifications>

In the above embodiment, the conductor wire 13 is composed of the electrically-conductive member 13a having a linear shape and the dielectric body 13b covering the electrically-conductive member 13a. However, not limited thereto, the conductor wire 13 may be composed only of the electrically-conductive member 13a having a linear shape, and a dielectric body may be formed between the electrically-conductive elastic body 12 and the electrically-conductive member 13a and between the electrically-conductive elastic body 22 and the electrically-conductive member 13a. Specifically, the dielectric body disposed between the electrically-conductive elastic bodies 12, 22 and the electrically-conductive member 13a may be formed on the surfaces of the electrically-conductive elastic bodies 12, 22.

In the above embodiment, as shown in FIG. 4, the load sensor 1 includes three sets of a plurality of the conductor wires 13 adjacent to each other. However, the load sensor 1 only needs to include at least one set of a plurality of the conductor wires 13 adjacent to each other. For example, the number of sets of the conductor wires 13 of the load sensor 1 may be 1.

In the above embodiment, as shown in FIG. 2B, the load sensor 1 includes three sets of electrically-conductive elastic bodies 12, 22 that oppose each other in the up-down direction. However, the load sensor 1 only needs to include at least one set of electrically-conductive elastic bodies 12, 22. For example, the number of sets of electrically-conductive elastic bodies 12, 22 included in the load sensor 1 may be 1.

In the above embodiment, the shape of the conductor wire 13 is a straight line shape in a plan view, but may be a wave shape. Further, the conductor wire 13 may be implemented by a twisted wire obtained by twisting a plurality of electrically-conductive members each covered by a dielectric body, or alternatively, may be implemented by a twisted wire obtained by twisting a plurality of electrically-conductive members, and a dielectric body covering the twisted wire.

In addition to the above, various modifications can be made as appropriate to the embodiment of the present invention without departing from the scope of the technical idea defined by the claims.

What is claimed is:

1. A load sensor configured to detect a load applied to a sensor part from outside, based on change in capacitance, the load sensor comprising:
two base members disposed so as to face each other;
two electrically-conductive elastic bodies respectively disposed on opposing faces of the two base members; and
a plurality of conductor wires disposed between the two electrically-conductive elastic bodies, wherein
the plurality of conductor wires are disposed under a condition that, when a diameter of each conductor wire is not greater than 0.3 mm, a gap between the plurality of conductor wires is not less than 0.6 mm, and when the diameter of each conductor wire is greater than 0.3 mm, the gap between the plurality of conductor wires is not less than twice the diameter of each conductor wire.

2. The load sensor according to claim 1, wherein
a maximum number of the conductor wires satisfying the condition are disposed.

3. The load sensor according to claim 1, wherein
the two electrically-conductive elastic bodies are disposed, extending in one direction,
a plurality of the sensor parts are disposed in the direction in which the two electrically-conductive elastic bodies extend, and
a plurality of the conductor wires satisfying the condition are disposed in each of the sensor parts.

4. The load sensor according to claim 1, wherein
a plurality of sets of the two electrically-conductive elastic bodies are disposed in one direction,
a plurality of the conductor wires satisfying the condition are disposed along the plurality of sets, and
the sensor part is disposed at each of positions where the plurality of sets of the two electrically-conductive elastic bodies and the plurality of conductor wires cross each other.

5. The load sensor according to claim 1, wherein
each conductor wire includes an electrically-conductive member having a linear shape, and a dielectric body covering the electrically-conductive member.

6. The load sensor according to claim 5, wherein
each electrically-conductive elastic body is configured to have a hardness of 10° to 90° or a Young's modulus of 3 MPa to 170 MPa.
